(19) United States
(12) Patent Application Publication
(10) Pub. No.: US 2015/0161687 A1
(43) Pub. Date: Jun. 11, 2015

(54) METHOD AND SYSTEM FOR DETERMINING COST OF MEDICAL PROCEDURES

(71) Applicant: EVEIA HEALTH Consulting and Management, Isaquah, WA (US)

(72) Inventors: Iphigenia Kehayes, Sammamish, WA (US); Robert M. Kilton, Bellevue, WA (US); Joel Rosenberger, Sammamish, WA (US); Stephanie L. Ream, Seattle, WA (US)

(21) Appl. No.: 14/564,783

(22) Filed: Dec. 9, 2014

Related U.S. Application Data
(60) Provisional application No. 61/913,791, filed on Dec. 9, 2013.

(51) Int. Cl. G06Q 30/02; G06Q 50/22; G06Q 30/04

(52) U.S. Cl. CPC G06Q 30/0283; G06Q 30/04; G06Q 50/22

(57) ABSTRACT

A method, a system, and a computer program for calculating the price (e.g., the amount of reimbursement that can be expected from a payor and the cost of the out of pocket portion of payment due from the patient) of medical procedures, including, e.g., accurate pre-pricing for medical procedures, based on various factors (e.g., carve-outs, accelerated/upfront payments, pay-for-performance, multiple procedure logic, a patient's specific insurance plan, coinsurance rate, deductible, copay, or the like) in timely and convenient manner.

### CROSS REFERENCE TO PRIOR APPLICATION

This application claims priority to and the benefit thereof from U.S. Provisional Patent Application, No. 61/913,791, filed on Dec. 9, 2013, titled “Method and System for Determining Cost of Medical Procedures,” the entirety of which is hereby incorporated herein by reference.

### FIELD OF THE DISCLOSURE

The present disclosure relates generally to a method, a system, and a computer program for determining the cost of medical procedures, and more specifically it relates to a method, a system and a computer program for determining a price (e.g., the amount of reimbursement that can be expected from a payor and the cost of the out of pocket portion of payment due from the patient) for a medical procedure in an easily navigated, accessible, and timely manner.

### BACKGROUND OF THE DISCLOSURE

In the United States today, there are many challenges facing the health care industry such as skyrocketing costs of health care and navigating increasingly complex insurance payment schemes. The days of a solo practitioner writing medical bills for services rendered are for the most part gone. Most medical offices and clinics have converted to computer and/or automatic billing systems.

In large hospitals and health care facilities, the billing departments are often virtually and/or entirely separate from the actual process of rendering medical care by medical professionals, such as, e.g., doctors, nurses, physician assistants, or the like. The people who work in the billing departments often have no medical training or background and are mainly concentrated on generating bills for medical services and collecting payment for the same. The bills sent out by the billing department can be complicated for both healthcare providers and patients. Part of the reason for the complexity is the current health insurance system includes, e.g., current procedural terminology (CPT) code, variations in payment systems and logic, of which, virtually there are no two payors alike, carve-outs, payor-specific insurance plans that vary by product, coinsurance rates, deductibles, copays, and the like. These complexities make it difficult for both the provider and the patient to understand the amount of expected payment from the third party payor and the amount of the payment that is due from the patient.

While most health care providers determine amounts due and bill patients after the procedures are completed, the amount that is due from the patient is dependent upon the amount that is negotiated with a commercial payor or stipulated as the allowed amount by a government payor. Therefore, the provider must understand what the allowed amount is by payor in order to inform the patient of their expected amount of payment and in order for the provider to collect the expected amount from the patient and the third party payor. Due to the complexities of medical payment systems, the allowed amount calculations are difficult for the average business office representative to calculate in an accurate and timely manner. Unfortunately, this can result in many issues if the business office does not know how much is due from the patient or the third party payor and does not have the ability to pre-price the expected amount due from the patient and the third party payor.

In order to address the root cause of, for example, pre-pricing challenges faced by healthcare providers, an unfilled need exists for a means to accurately calculate the pre-pricing for medical procedures in timely and convenient manner.

### SUMMARY OF THE DISCLOSURE

The present disclosure provides a method, a system, and a computer program for determining the expected payment amount due from the third party payor and the cost of a medical procedure to the patient. The method for processing payor contract data, comprises: receiving payor contract data; determining whether the payor contract data corresponds to contract data for an existing payor; updating a stored payor contract record based on the receiving payor contract data upon determining that the payor contract data corresponds to an existing payor; and creating a new payor contract record upon determining that the payer contract data corresponds to a new payor.

The step of updating the stored payor contract record may comprise: determining that the received payor contract data includes a change in price, a change in contract term, or a change in contract condition; and updating the stored payor contract record to reflect the change in price, change in contract term, or change in contract condition.

The step of creating a new payor contract record may comprise: comparing the payor contract data to one or more contract models; and creating the new payor contract record based on a closest match to the one or more contract models.

The step of receiving the payor contract data may comprise receiving a communication, over a network, of the payor contract data.

The method may further comprise converting the received payor contract data into an intermediate format; and/or storing the received payor contract data into a payor contracts database, the database comprising a plurality of storage regions, each storage region associated with a payor.

According to a further aspect of the disclosure, a method is provided for determining a price for a medical procedure in advance of the procedure being performed, comprising: receiving, from a service provider, a request for price determination, the request identifying one or more third party payors responsible for at least a portion of the price of the medical procedure; retrieving payor contract data for the identified one or more third party payors; receiving a description of the medical procedure; and computing the price for the medical procedure, the price including the third party payor responsibility and a patient responsibility.

The description of the medical procedure may include one or more codes associated with performing the procedure.

The step of computing the price may include determining, based on the payor contract data and the description of the medical procedure, a total expected payment, an estimated insurance payment amount, and an estimated patient balance.

The method may further comprise: comparing the retrieved payor contract data to one or more stored payor contract records; determining whether the payor contract data corresponds to one of the one or more stored payor contract records; and creating a new payor contract record upon determining that the payer contract data corresponds to a new payor.

The method may further comprise saving the computed price for the medical procedure.

The method may further comprise: retrieving a saved computed price; and revising the saved computed price.

The method may further comprise: upon retrieving the payor contract data, reviewing effective payor term dates; and computing the price based on a contract allowed amount.

According to a still further aspect of the disclosure, a method is disclosed for processing payor contract data, comprising: receiving payor contract data; determining whether the payor contract data corresponds to contract data for an existing payor; and updating a stored payor contract record or creating a new payor contract record based on the received contract data.

The step of updating the stored payor contract record may comprise: determining that the received payor contract data includes a change in price, a change in contract term, or a change in contract condition; and updating the stored payor contract record to reflect the change in price, change in contract term, or change in contract condition.

The step of creating a new payor contract record may comprise: comparing the payor contract data to one or more contract models; and creating the new payor contract record based on a closest match to the one or more contract models.

The step of receiving the payor contract data may comprise receiving a communication, over a network, of the payor contract data. The method may further comprise: converting the received payor contract data into an intermediate format; and/or storing the received payor contract data into a payor contracts database, the database comprising a plurality of storage regions, each storage region associated with a payor.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the invention in more detail than may be necessary for a fundamental understanding of the disclosure and the various ways in which it may be practiced.

FIG. 1 shows an example of a system that is constructed according to the principles of this disclosure.

FIG. 2A shows an example of a method for determining a price for a procedure according to principles of this disclosure.

FIG. 2B shows an example of a method for calculating a price for a procedure according to the principles of this disclosure.

FIG. 3 shows an example of a technical architecture according to the principles of the disclosure.

FIG. 4 shows an example of a method according to the principles of this disclosure.

FIG. 5 shows an example of an interface that may be used by a surgical center.

FIG. 6 shows an example of an interface that may be used by a patient.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure.

A “computer,” as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like.

A “server,” as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database,” as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “communication link,” as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, and the like.

A “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, the Internet, or the like, or any combination of the foregoing, any of which may be configured to communicate data via a wireless and/or a wired communication medium. These networks may run a variety of protocols not limited to TCP/IP, IRC or HTTP.

The terms “including,” “comprising” and variations thereof, as used in this disclosure, mean “including, but not limited to,” unless expressly specified otherwise.

The terms “a,” “an,” and “the,” as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium,” as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium may include a “Cloud,” which includes a distribution of files across multiple (e.g., thousands of) memory caches on multiple (e.g., thousands of) computers.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

After many years spent successfully negotiating thousands of contracts between Ambulatory Surgical Centers (ASC) and insurance companies, a unique insight has been gained into means to address some of the issues facing current billing systems used, for example, by service providers and related facilities. Specifically, it was found that complexities related to third-party payor (e.g., health insurance, a government agency, a benefit plan, or the like) contracts and payment schemes often make it difficult to determine the price (e.g., the amount of reimbursement that can be expected from a payor and the cost of the out-of-pocket portion of payment due from the patient) for medical procedures in advance of such procedures being performed by, e.g., health care providers. Some of the complexities include, e.g., current procedural terminology (CPT), variation in payment system and logic, of which, virtually there are no two payors alike, payor-specific insurance plans that vary by product, coinsurance rates, accelerated/upfront payment requirements, pay-for-performance requirements, coinsurance rate requirements, deductible requirements, copay requirements, the specific medical procedure to be performed, and the like. The system and method of the instant disclosure address these challenges, as well as other challenges that will be evident to anyone skilled in the art.

For example, the instant disclosure provides a web-based solution that may provide a unique solution for each service provider that is tailored to the service provider's needs, payor contracts, and patients. The solution enables administrative staff to quickly and easily pre-price surgical procedures based on a specific insurance plan, coinsurance rate, deductible and copay. Additionally, the solution provides pre-pricing for Medicare and Worker Compensation rates.

The solution provides many benefits to service providers, including, e.g., easy determination of patient's responsibility related to a procedure, easy determination of a provider's revenue from the procedure, increased confidence to provider staff (e.g., they do not have to guess or try to evaluate insurance contracts), new revenue opportunities, comparisons of payor payments, reconciliation of actual procedure payments from payor, improving cash flow and decreasing receivables, providing for upfront patient collections, facilitating payment of the growing consumer liability market, reducing patient bad debt, reducing workload on center administrators, and the like.

The solution provides many benefits to patients, including, e.g., reducing confusion and uncertainty about balances owed, informing patients about out-of-pocket costs prior to time of service, increasing satisfaction levels with provider, and the like.

The solution also provides many benefits to payers, including, e.g., reducing appeals due to confusion about claims, bringing clarity to insurance payments, providing insurance members with information to allow them to make cost-conscious decisions, and the like.

The disclosed method, system, and computer program provide the solution, which closely estimates a price for a service (such as, e.g., a medical procedure, a surgical procedure, drug prescription, or the like) based on, e.g., a specific insurance plan, a coinsurance rate, a deductible, copay, and the like. In estimating the price (e.g., the amount of reimbursement that can be expected from a payor and the cost of the out-of-pocket portion of payment due from the patient) of a service in advance of the service being performed, the solution may take a variety of additional factors into consideration in determining the cost, including but not limited to e.g., current procedural terminology (CPT), contract carve out requirements, accelerated/upfront payment requirements, pay-for-performance requirements, multiple procedure requirements, patient-specific insurance plan requirements, coinsurance rate requirements, policy deductible requirements, contract copay requirements, the specific medical procedure requirements, and the like.

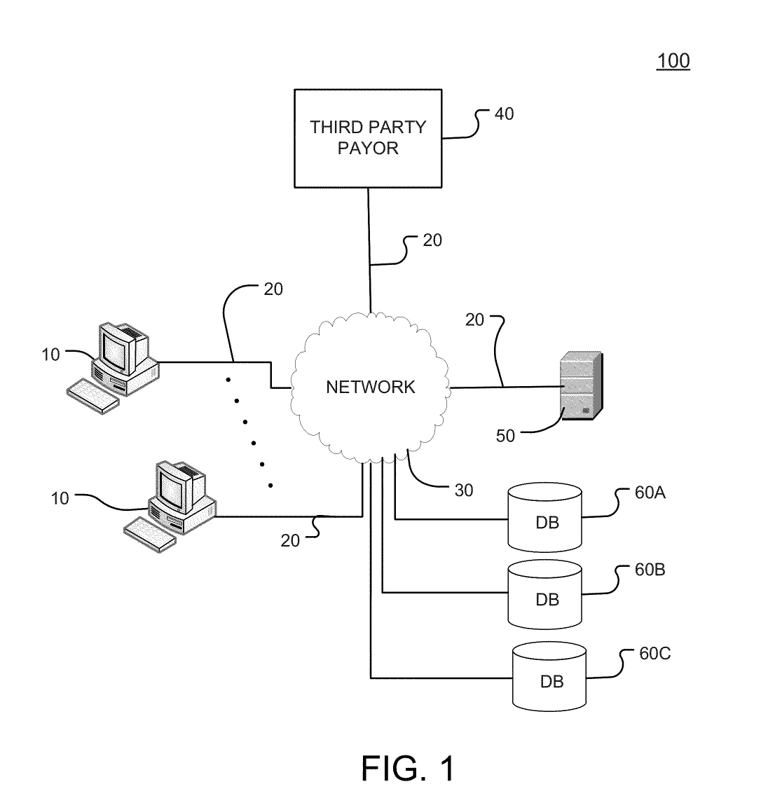

FIG. 1 shows an example of a system 100 that is constructed according to the principles of the disclosure. The system 100 determines a cost of a service to be rendered to a specific patient based on an associated payor contract, in advance of the service being rendered. The system 100 includes a service provider (e.g., a billing professional, a hospital manager, a hospital or medical practice administrator, or the like) computer 10, a network 30, a payor computer 40, a server (or computer) 50, and at least one database 60 (e.g., databases 60A-C), all of which may be coupled to each other via communication links 20. For instance, the server 50 and database 60 may be connected directly to each other and/or through the network 30 via one or more communication links 20. The service provider (SP) computer 10 and the third party payor (TPP) computer 40 may be coupled to each other directly or through the network 30 via communication links 20. The SP computer(s) 10 may also be used by, for example, doctors, nurses, physician's assistants, receptionists, assistants, or the like.

The TPP computer 40 may include a payor interface (not shown) where a payor may input or load contract data for one or more payor contracts. The payor contract may include, a policy identifier, a contract identifier, a payor contract, a payor fee schedule, and the like, which may include terms and conditions by which the payor will pay for a service rendered to a policy holder. The payor contract data may include a fee schedule. The payor contract data may include, for example, the payor contract(s), the payor fee schedule(s), information that is derived from a payor contract, such as, e.g., an identification of covered medical procedures, an identification of covered pharmaceuticals (e.g., branded or generic pharmaceuticals), an identification of covered medical equipment (e.g., devices, implants, catheters, crutches, bandages, dentures, dental implants, surgical services, and the like), co-pay amounts, deductibles, policy carve outs, reimbursement rates for a particular procedure or particular equipment, reimbursement rates per procedure or equipment, benefit provisions, and the like.

The contract data may be sent from the TPP40 over the communication link 20 and network 30 to the server 50. The contract data may be processed by the server 50, as described below, and stored in the database 60B. The database 60B may include a library of medical payor contracts. This library may also include information on government provided programs, e.g., government/military provided health insurance, benefits program, or the like. The database 60B may include a plurality of storage regions, each associated with a particular third party payor. Each third party payor storage region may include one or more records that include payor contract data, including, e.g., medical payor contracts, which may include entire contracts, fee schedules, portions of the contracts, and the like.

The database 60A may hold current procedural terminology (CPT), CPT code metrics and the like. The data in the database 60A may be periodically (or continuously) updated, so as to include the most up to date terminology and code metrics.

The database 60C may include service provider data, including, for example, account number, name, location, telephone number, address, email address, telephone number, third party payor contracts that are accepted by SP, terms and conditions of service specified by SP, and the like.

The databases 60A-60C may include one or more levels of authorization for granting access to different users, which may be changed by, e.g., a system administrator from time to time.

The computers 10, 40, server 50, and the database 60 may each include a computer-readable medium comprising a computer program that may be executed to carry out the processes disclosed herein. The computer-readable medium may include a code section or code segment for performing each step disclose herein.

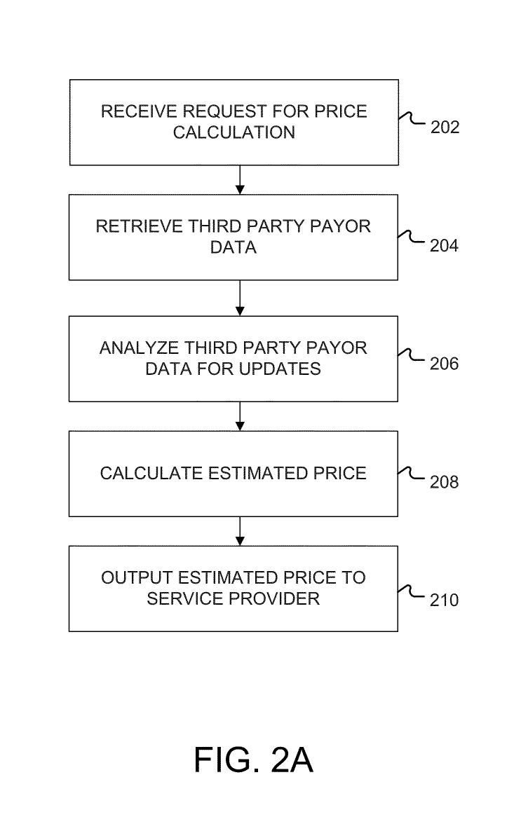

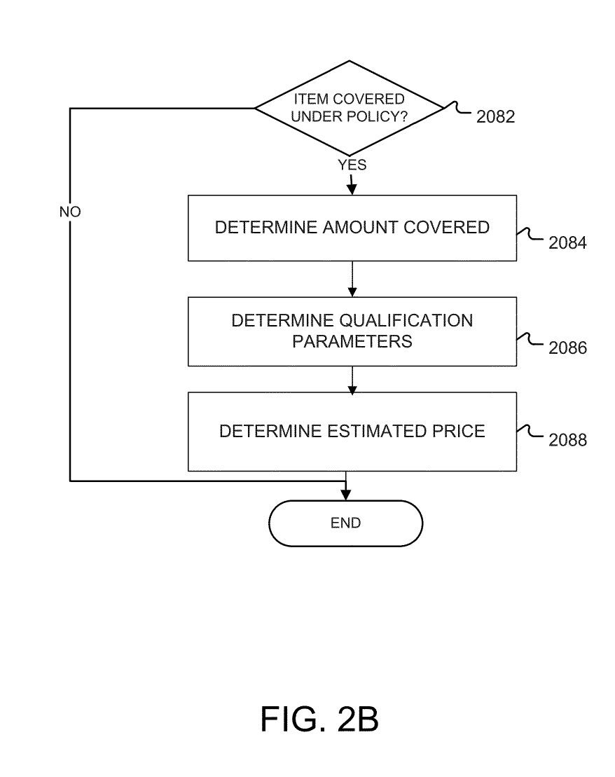

FIG. 2A shows a high-level example of a method 200 for determining the price of a procedure. As described herein, the price includes both amounts expected from third party payors as well as the cost of a procedure to the patient. The method 200 may begin, for example, upon receipt of a request from a service provider to calculate a price for one or more procedures, as shown at 202. The request may include, for example, an identification of one or more payor contracts associated with the patient and an identification of the one or more procedures to be performed. For example, the patient may be enrolled in one or more private or government sponsored insurance plans, and the request may identify such plans by name, plan number, etc. The identification of one or more procedures to be performed may include, for example, current procedural terminology (CPT) codes or descriptors.

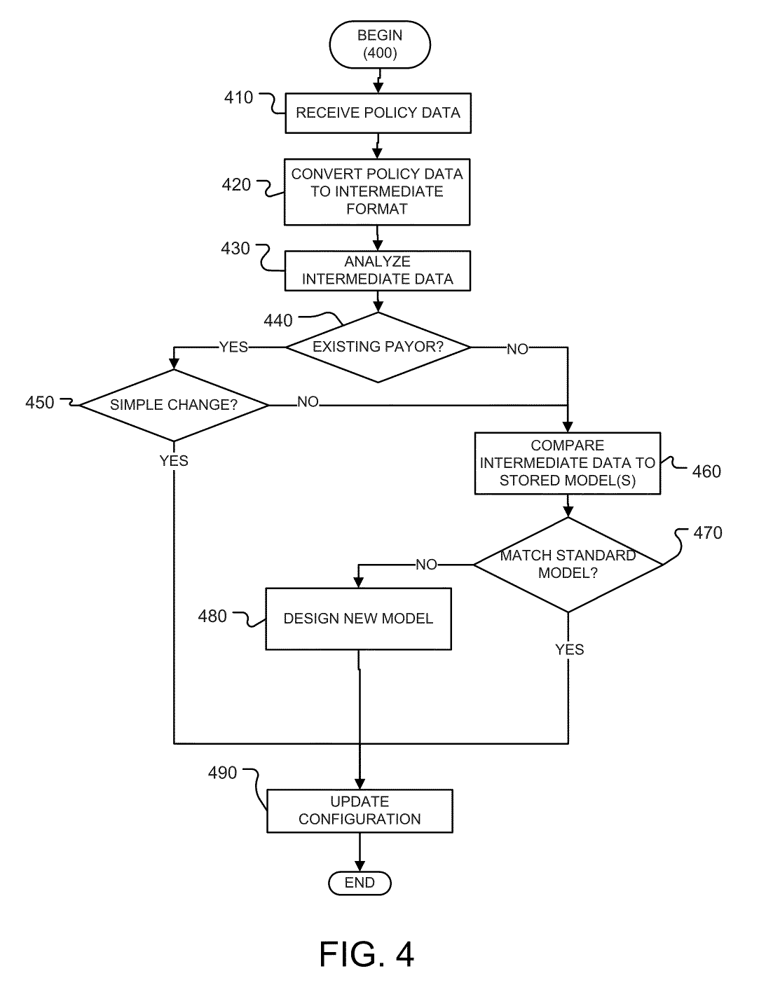

As shown at 204, third party payor data may be retrieved for the one or more payor contracts. For example, the third party payor data may be retrieved through electronic communication with the third party payor to retrieve the data. As shown at 206, the third party payor data is analyzed to determine whether locally stored data should be updated. This process is described in more detail with respect to FIG. 4.

As shown at 208, the price is calculated based on the payor contract, and as shown at 210, the price information is presented to the service provider.

FIG. 2B shows an example of a method for calculating estimated price that may be performed at 208 in FIG. 2A.

Referring to FIG. 2B, after the third party payer data is analyzed at 206 (in FIG. 2A), a determination may be made as to whether the item is covered under the contract (or policy), at 2082. The item may include, e.g., a medical procedure, a surgical procedure, a dental procedure, and the like. The item may include, e.g., a prescription, a pharmaceutical, a drug, a medical equipment (e.g., a catheter, a dental implant, a pacemaker, and the like), a medical-related equipment (e.g., a crutch, a bandage, and the like), and the like.

If a determination is made that the item is covered under the contract (Yes at 2082), then a determination may be made as to the amount covered under the particular contract for the particular item at 2084. Further, a determination may be made as to the market price for the particular item in, e.g., the relevant geographic location of the patient at 2084.

At 2086, one or more qualification parameters may be determined for the particular contract, including, e.g., the coinsurance rate, accelerated/upfront payment requirements, copay requirements, patient-specific plan requirements, and the like.

At 2088, the estimated price for the item may be determined based on the amount covered (at 2084) and the applicable qualification factors (2086).

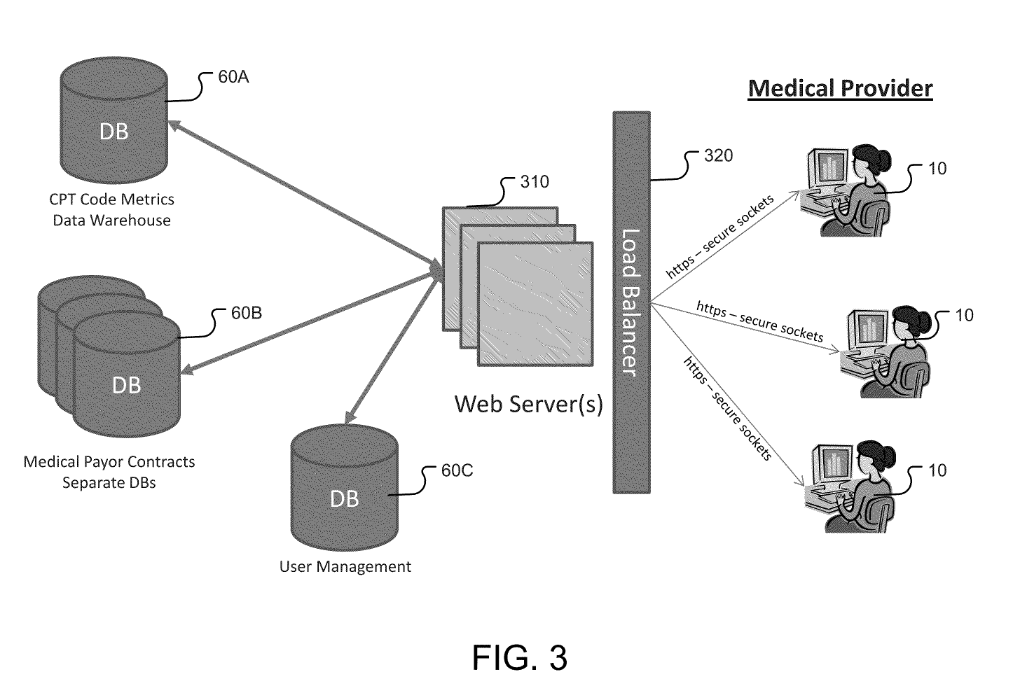

FIG. 3 shows an example of the technical architecture that may be implemented in the system 100, according to the principles of the disclosure. As shown in FIG. 3, database 60A may store CPT code metrics, database(s) 60B may store medical payor contract data, and database 60C may store user management data, including service provider data. Each database may be accessed by one or more web servers 310. The web servers 310 may be configured corresponding to server 50, shown in FIG. 1, which may be configured to process and store third party payor data, and to use the third payor data to calculate the price of medical procedures. A load balancer 320 may be provided for distributing data traffic between web servers 310 and one or more service providers 10. As shown in FIG. 3, each service provider 10 may access web servers 310 via secure communication links.

FIG. 4 shows an example of a process 400 that may be carried out for analyzing and updating third party payor contract data by the system 100 (shown in FIG. 1), according to the principles of the disclosure.

Referring to FIGS. 1 and 4 simultaneously, the process 400 may be initiated in response to a request from a service provider using, e.g., SP computer 10. Policy data may be received at the server 50 (Step 410). The policy data may include payor contract data, including, e.g., payor contracts, payor policies, government stipulations, payor fee schedules, government/military health insurance/benefits program and the like. The policy data may be converted to intermediate data (Step 420). The intermediate data may be in a format that is readily readable by the server 50. For instance, the policy data may include a fee schedule that is converted to, e.g., an Excel spreadsheet. The intermediate data is analyzed (Step 430) to determine whether the intermediate data is for a new or existing client (Step 440).

If it is determined that the intermediate data is for an existing client (YES at Step 440), then a determination is made based on the analyzed intermediate data whether a minor change has been made to, e.g., a payor contract, such as, e.g., a change in price, a contract term, a contract condition, or the like (Step 450).

If it is determined that a minor change has been made (YES at Step 450), then the record(s) in the database 60B associated with the existing client, including the associated configuration, is updated and stored (Step 490).

If it is determined that the intermediate data is for a new client (NO at Step 440), then the analyzed intermediate data is compared to previously stored models (Step 460) and a record is created for the new client in the database 60B.

If it is determined that a change has not been made, or that a substantial change has been made (NO at Step 450), then the intermediate data is compared to one or more stored models (Step 460) e.g., percentage of procedure cost, grouper (e.g., based on payor setting reimbursement amount for groups of CPT codes), ambulatory payment classification (APC) (e.g., based on percentage of published medicare costs), and so on. If a match is found (YES at Step 470), then the record(s) in the database 60B associated with the existing client, including the associated configuration, is updated and stored (Step 490).

If a match is not found (NO at Step 470), then a new model is created based on the intermediate data (Step 480) and the record(s) in the database 60B associated with the existing client is updated and stored, including a new configuration associated with the new model (Step 490).

Updates to configurations may include, e.g., a reimbursement rate requirement, information about a policy carve out, a copay amount requirement, a deductible amount requirement, a co-insurance requirement, and the like. The updated configuration may be used to pre-price a medical procedure, including, e.g., a total cost for the procedure, for associated medication, copay amount, and the like.

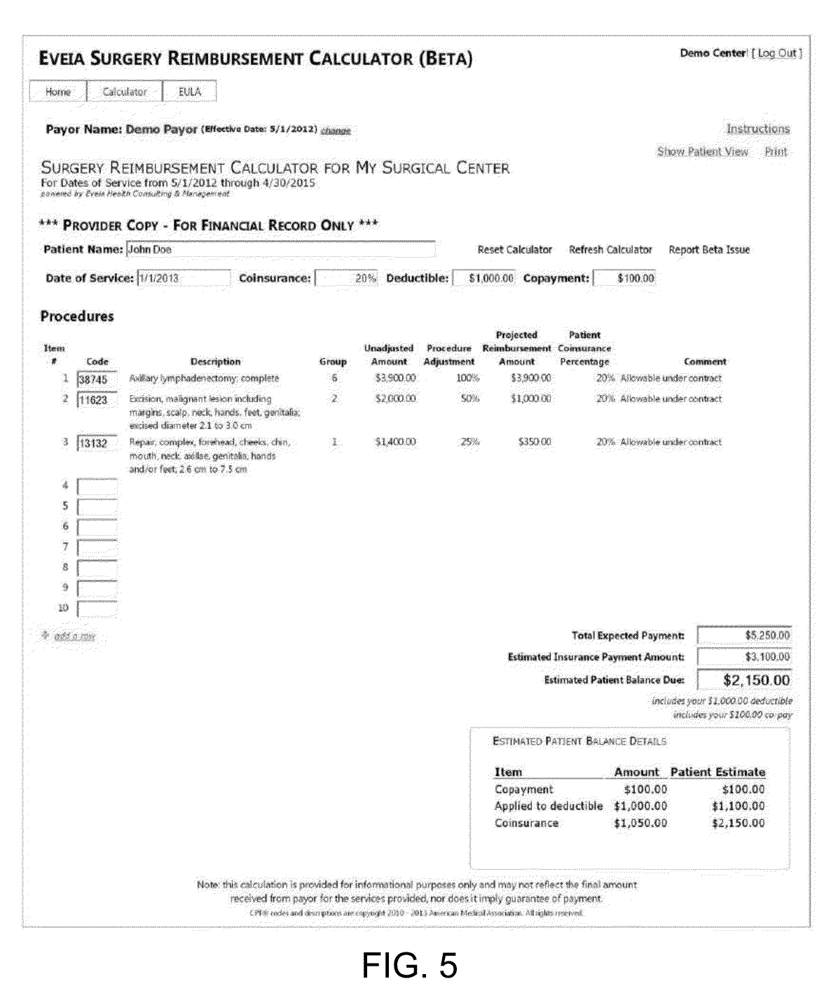

FIG. 5 shows an example of a Surgery Reimbursement Calculator interface that may be provided on the SP computer 10 (shown in FIG. 1) for use by a service provider contracted with the payor, according to the principles of the disclosure. As shown in FIG. 5, a service provider may input the payor name, patient data, and codes associated with procedures to be performed. The information may be transmitted to server 50 (shown in FIG. 1), which computes the total expected payment based on the third party payor information. The calculator interface allows a user (e.g., a service provider) to easily see amounts owed by the third party payor (insurance company) and the patient.

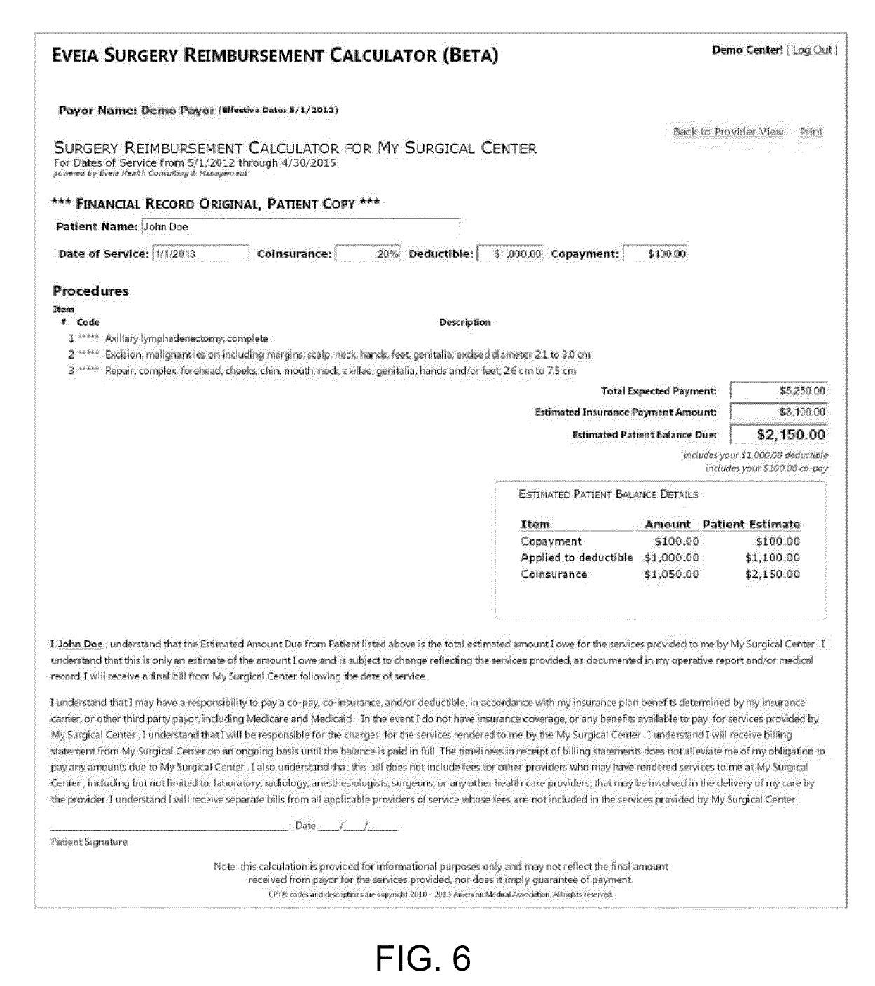

FIG. 6 shows an example of the Surgery Reimbursement Calculator interface that may be provided on the SP computer 10 for use by the patient of the service provider. This view presents information pertinent to the patient, allowing the patient to easily see the patient's responsibility for a procedure prior to undergoing the procedure.

While the disclosure has been described in terms of exemplary embodiments, those skilled in the art will recognize that the disclosure can be practiced with modifications in the spirit and scope of the appended claims and drawings. The examples provided herein are merely illustrative and are not meant to be an exhaustive list of all possible designs, embodiments, applications or modifications of the disclosure.

What is claimed:

1. A method for processing payor contract data, comprising:
receiving payor contract data;
determining whether the payor contract data corresponds to contract data for an existing payor;
updating a stored payor contract record based on the receiving payor contract data upon determining that the payor contract data corresponds to an existing payor; and
creating a new payor contract record upon determining that the payer contract data corresponds to a new payor.

2. The method of claim 1, wherein updating the stored payor contract record comprises:
determining that the received payor contract data includes a change in price, a change in contract term, or a change in contract condition; and
updating the stored payor contract record to reflect the change in price, change in contract term, or change in contract condition.

3. The method of claim 1, creating a new payor contract record comprises:
comparing the payor contract data to one or more contract models; and
creating the new payor contract record based on a closest match to the one or more contract models.

4. The method of claim 1, wherein receiving the payor contract data comprises receiving a communication, over a network, of the payor contract data.

5. The method of claim 1, further comprising:
converting the received payor contract data into an intermediate format.

6. The method of claim 1, further comprising:
storing the received payor contract data into a payor contracts database, the database comprising a plurality of storage regions, each storage region associated with a payor.

7. A method for determining a price for a medical procedure in advance of the procedure being performed, comprising:
receiving, from a service provider, a request for price determination, the request identifying one or more third party payors responsible for at least a portion of the price of the medical procedure;
retrieving payor contract data for the identified one or more third party payors;
receiving a description of the medical procedure; and
computing the price for the medical procedure, the price including the third party payor responsibility and a patient responsibility.

8. The method of claim 7, wherein the description of the medical procedure includes one or more codes associated with performing the procedure.

9. The method of claim 7, wherein computing the price includes determining, based on the payor contract data and the description of the medical procedure, a total expected payment, an estimated insurance payment amount, and an estimated patient balance.

10. The method of claim 7, further comprising:
comparing the retrieved payor contract data to one or more stored payor contract records;
determining whether the payor contract data corresponds to one of the one or more stored payor contract records; and
creating a new payor contract record upon determining that the payer contract data corresponds to a new payor.

11. The method of claim 7, further comprising:
saving the computed price for the medical procedure.

12. The method of claim 11, further comprising:
retrieving a saved computed price; and
revising the saved computed price.

13. The method of claim 7, further comprising:
upon retrieving the payor contract data, reviewing effective payor term dates; and
computing the price based on a contract allowed amount.

14. A method for processing payor contract data, comprising:
receiving payor contract data;
determining whether the payor contract data corresponds to contract data for an existing payor; and
updating a stored payor contract record or creating a new payor contract record based on the received contract data.

15. The method of claim 14, wherein updating the stored payor contract record comprises:
determining that the received payor contract data includes a change in price, a change in contract term, or a change in contract condition; and
updating the stored payor contract record to reflect the change in price, change in contract term, or change in contract condition.

16. The method of claim 14, creating a new payor contract record comprises:
comparing the payor contract data to one or more contract models; and
creating the new payor contract record based on a closest match to the one or more contract models.

17. The method of claim 14, wherein receiving the payor contract data comprises receiving a communication, over a network, of the payor contract data.

18. The method of claim 14, further comprising:
converting the received payor contract data into an intermediate format.

19. The method of claim 14, further comprising:
storing the received payor contract data into a payor contracts database, the database comprising a plurality of storage regions, each storage region associated with a payor.
